(19) United States
(12) Patent Application Publication
(10) Pub. No.: US 2005/0158598 A1
(43) Pub. Date: Jul. 21, 2005

(54) Fuel cell structure and method for the operation of a fuel cell structure

(75) Inventors: Marc Steinfort, Ismaning (DE); Gerhard Huppmann, Feldkirchen-Westerham (DE)

Correspondence Address: CROWELL & MORING LLP;INTELLECTUAL PROPERTY GROUP, P.O. BOX 14300, WASHINGTON, DC, 20044-4300, US

(73) Assignee: MTU CFC Solutions GmbH, Ottobrunn (DE)

(21) Appl. No.: 10/498,490

(22) PCT Filed: Dec. 10, 2002
(86) PCT No.: PCT/EP02/13977

(30) Foreign Application Priority Data
Dec. 15, 2001 (DE) 101 61 838.7

(51) Int. Cl. H01M 8/04

(52) U.S. Cl. 429/26; 429/22; 429/34; 429/13

(57) ABSTRACT

A fuel cell assembly has fuel cells, each containing an anode and a cathode. A fresh-air feed is used for feeding fresh air to the cathode input. Between the anode output and the cathode input, by way of an anode waste gas return pipe, a burner device is provided for afterburning of combustible residual constituents contained in the spent fuel gas leaving the anode output, optionally together with fresh air fed by way of the fresh-air feed. The fresh-air feed contains a first fresh-air feed pipe connected to the burner device, for optional feeding of fresh air together with the spent fuel gas to the burner device, as well as a second fresh-air feed pipe for feeding fresh air to the cathode input while bypassing the burner device. The amount of the fresh air fed to the burner device by way of the first fresh-air feed pipe is preferably adjusted such that a temperature of between 750° C. and 1,400° C., preferably between 850° C. and 1,250° C., occurs in the burner device.

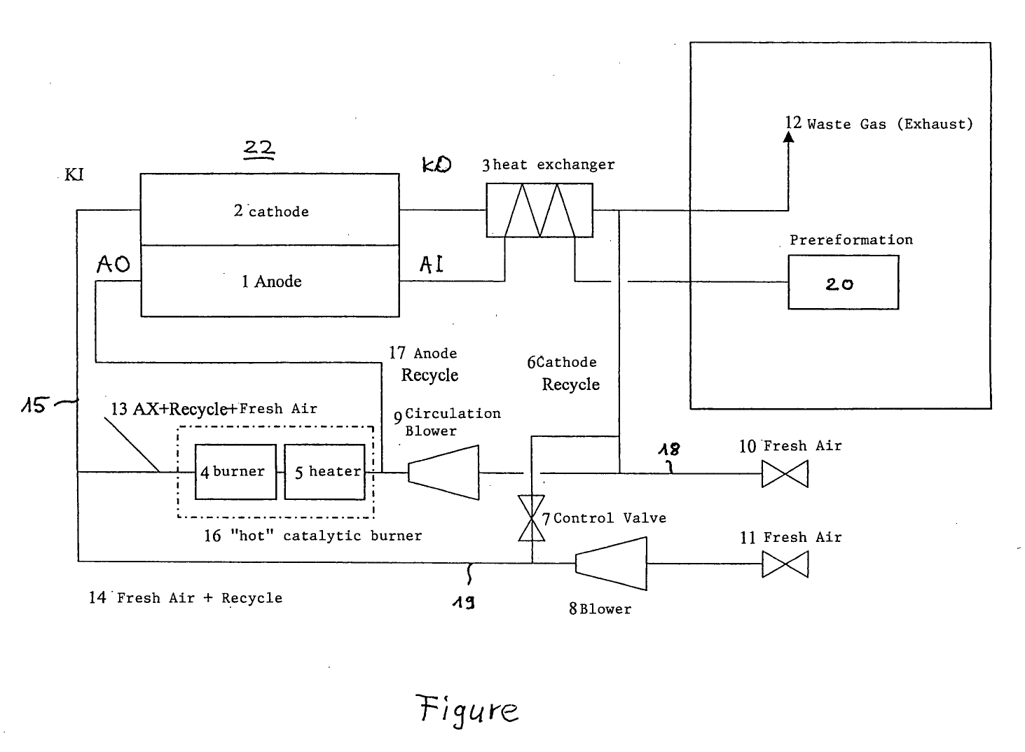

This application claims the priority of German patent document 101 61 838.7, filed 15 Dec. 2001 (PCT International Application No. PCT/EP02/13977, filed 10 Dec. 2002), the disclosure of which is expressly incorporated by reference herein.

### BACKGROUND AND SUMMARY OF THE INVENTION

The invention relates to a fuel cell arrangement, and to a method of operating such a fuel cell arrangement.

In known fuel cell arrangements, the individual fuel cells each contain an anode and cathode respectively. An anode input feeds fresh fuel gas to the anodes and an anode output removes spent fuel gas from the anodes; similarly, a cathode input feeds fresh cathode gas to the cathodes, and a cathode output removes spent cathode gas from the cathodes. The fuel cell arrangement also includes a fresh-air feed for feeding fresh air to the cathode input, and a burner device connected by way of an anode waste gas return pipe between the anode output and the cathode input, for afterburning of combustible residual constituents contained in the spent fuel gas leaving the anode output, optionally together with fresh air fed by way of the fresh-air feed.

In previously known fuel cell arrangements, the burner device contains a catalytic burner in which the combustible residual constituents of the spent fuel gas are burnt at temperatures between approximately 500 to 700° C. together with the fresh air fed from the outside. These comparatively low combustion temperatures are a result of the fact that, in the case of the known fuel cell arrangements, practically the entire amount of the fed fresh air and possibly the cathode waste gas partially returned from the cathode output also to the burner device, for energy-related reasons, did not permit higher combustion temperatures. Thus, combustion without a catalyst (which, as a rule, is expensive and requires defined operating temperatures) was impossible.

One object of the present invention is to provide a fuel cell arrangement of the above-mentioned type, in which combustion of the combustible residual constituents in the spent anode fuel gas takes place at a higher temperature, and a method of operating such a fuel cell arrangement.

The invention provides a fuel cell arrangement having one or more fuel cells, each of which contains an anode and a cathode. An anode input is provided for feeding fresh fuel gas to the anodes, and an anode output for removing spent fuel gas from the anodes; in addition, a cathode input is provided for feeding fresh cathode gas to the cathodes, and a cathode output for removing spent cathode gas from the cathodes. A fresh-air feed supplies fresh air to the cathode input, and a burner device is connected by way of an anode waste gas return pipe between the anode output and the cathode input. The burner device performs afterburning of combustible residual constituents contained in the spent fuel gas leaving the anode output, optionally together with fresh air fed by way of the fresh-air feed. According to the invention, the fresh-air feed has a first fresh-air feed pipe connected to the burner device, for optional feeding of fresh air together with the spent fuel gas to the burner device, and a second fresh-air feed pipe for the feeding of fresh air to the cathode input, while bypassing the burner device.

It is a significant advantage of the fuel cell arrangement according to the invention that the combustion of the combustible residual constituents in the spent fuel gas can take place at a higher temperature, so that fewer noble catalysts need be used in the burner device or no catalysts may even be required at all.

Preferably, regulating devices are provided for adjusting the fresh air quantities fed by way of the first and second fresh-air feed pipes, as well as blowers for delivering adjustable amounts of fresh air.

According to a preferred embodiment of the invention, a cathode waste gas return pipe is coupled between the cathode output and the burner device and/or the cathode input, for returning at least a portion of the cathode waste gas to either or both of the latter.

In a preferred embodiment for returning a portion of the cathode exhaust gas, the cathode waste gas return pipe is coupled with the burner device; and for returning a portion of the cathode exhaust gas to the cathode input, the return pipe is coupled to the latter by way of the second fresh-air feed pipe. A regulating valve is provided for adjusting the ratio of the cathode exhaust gas quantities returned to the burner device and to the cathode input respectively.

The burner device preferably contains a burner for burning the combustible residual constituents contained in the anode waste gas and a heating device for heating the fresh air fed by way of the first fresh-air feed pipe.

The burner device may contain a catalytic burner. In a preferred embodiment of the invention, it contains a burner formed by a foam structure. The catalytic burner may be formed by a catalytic coating constructed on the foam structure.

The heating device preferably is an electric heating device formed by an electrically conductive foam material.

Advantageously, the catalytic burner may be provided in the form of a catalytic coating on the foam structure of the heating device, which may be made of special steel (preferably of FeCrAlY), steel or a conductive ceramic material.

The invention also provides a method of operating a fuel cell arrangement of the type described above. According to the invention, the amounts of the fresh air fed by way of the first fresh-air feed pipe to the burner device are adjusted such that a temperature of between 750° C. and 1,400° C. (preferably between 850° C. and 1,250° C.) occurs during the afterburning of the combustible residual constituents contained in the spent fuel gas in the burner device.

According to a preferred embodiment of the method of the invention, the entire flow of the spent fuel gas is returned by way of the anode gas return pipe to the burner device.

According to another preferred embodiment of the method according to the invention, the entire flow of the cathode waste gas returned by way of the cathode waste gas return pipe is returned to the burner device.

According to an alternative embodiment of the method according to the invention, the flow of the cathode waste gas returned by way of the cathode waste gas return pipe is returned partly to the burner device and partly to the cathode input.

According to an embodiment of the method according to the invention, the flows of the spent fuel gas and of the cathode waste gas can be guided through the burner device without another addition of fresh air.

According to another embodiment of the method according to the invention, a portion of the fresh air can be fed by way of the first fresh-air feed pipe to the burner device.

Finally, in an embodiment according to the method of the invention, the entire flow of the cathode waste gas returned by way of the cathode waste gas return pipe is returned to the cathode input while bypassing the burner device. The fresh-air flow is exclusively fed by way of the first fresh-air feed pipe to the burner device or is partly fed by way of the first fresh-air feed pipe to the burner device and partly by way of the second fresh-air feed pipe to the cathode input, while bypassing the burner device.

Other objects, advantages and novel features of the present invention will become apparent from the following detailed description of the invention when considered in conjunction with the accompanying drawings.

### BRIEF DESCRIPTION OF THE DRAWINGS

The figure is a block diagram of a fuel cell arrangement according to an embodiment of the invention.

### DETAILED DESCRIPTION OF THE DRAWINGS

The figure is a schematic block diagram of a fuel cell arrangement, which typically contains a number of fuel cells arranged in the form of a fuel cell stack. For the purpose of better clarity, only a single fuel cell 22 of the stack is shown in the figure.

The fuel cell 22 contains an anode 1 and a cathode 2, between which an electrolyte matrix is arranged (not shown separately in the figure). The anode has an anode input AI for feeding fresh fuel gas (anode gas) and an anode output AO for removing the spent fuel gas from the anode 1. Likewise, the cathode 2 has a cathode input KI for feeding fresh cathode gas and a cathode output KO for removing the spent cathode gas from the cathode 2. The fresh fuel gas is fed to the anode input AI from a pre-reforming device 20 by way of a heat exchanger 3. The spent cathode gas is emitted from the cathode output KO by way of the heat exchanger 3, where it transfers its waste heat to the fresh fuel gas, to a waste gas discharge 12. Fresh air is fed as cathode gas to the cathode input KI by way of a cathode inlet pipe 15 by a fresh-air feed 18, 19, which contains a first fresh-air feed pipe 18 and a second fresh-air feed pipe 19.

Between the anode output AO and the cathode input KI, an anode waste gas return pipe 17 is provided into which a burner device 16 is connected. The latter is used for afterburning of combustible residual constituents contained in the spent fuel gas.

At the input of the burner device 16, the anode waste gas return pipe is combined with the first fresh-air feed pipe 18, which optionally delivers fresh air to the burner device 16, via a circulation blower 9. The amount of air can be adjusted by a fresh-air control valve 10. The second fresh-air feed pipe 19 is used for feeding fresh air directly to the cathode inlet pipe 15 or to the cathode input KI, via a blower 8. The volume of such air amount can be adjusted by a fresh-air control valve 11, while bypassing the burner device 16.

A cathode waste gas return pipe 6 is coupled from a point on the cathode waste gas pipe 12 (downstream of the heat exchanger 3), directly to the first fresh-air feed pipe 18 on one side, and to the second fresh-air feed pipe 19 via a control valve 7, on the other side. The cathode waste gas return pipe 6 returns at least a portion of the cathode waste gas in the waste gas pipe 12 to the burner device 16 by way of the first fresh-air feed pipe 18, or directly to the cathode inlet pipe 15 or the cathode input KI by way of the control valve 7 and the second fresh-air feed pipe 19. The cathode waste gas flow returned by way of the cathode waste gas return pipe 6 can be controlled independently of the amount of the air supplied through the first and second fresh-air feed pipes 18 and 19, and thus also when either or both of the fresh-air control valves 10, 11 are closed.

The burner device 16 contains a burner 4 for burning the combustible residual constituents contained in the anode waste gas and a heating device 5 for heating the fresh air fed by way of the first fresh-air feed pipe 18 together with the anode waste gas. It is possible also to feed only fresh air, particularly when starting the operation of the fuel cell arrangement.

The burner 4 contained in the burner device 16 may contain a catalyst material and is preferably formed by a foam structure. The catalyst material may be provided by a catalytic coating constructed on the foam structure.

The heating device 5 is preferably an electric heating device, formed by the structure of the foam material of the burner 4. In this case, an electrically conductive material will then be provided. The catalytic coating may be provided on the foam structure of the heating device 5, so that the burner 4 and the heating device 5 can be provided in a common element. In particular, the foam structure may consist of special steel (preferably FeCrAlY), steel or a conductive ceramic material.

The amounts of the fresh air fed by way of the first fresh-air feed pipe 18 to the burner device 16 are adjusted taking into account the amount of the anode waste gas returned by way of the anode waste gas return pipe 17 from the anode output AO to the burner device 16, such that, during the afterburning of the combustible residual constituents contained in the spent fuel gas, in the burner device 16, a temperature occurs of between 750° C. and 1,400° C. (preferably between 850° C. and 1,250° C.).

Preferably, as in the case of the embodiment illustrated in the figure, the entire flow of the spent fuel gas is returned from the anode output AO by way of the anode waste gas return pipe 17 to the burner device 16.

Either the entire amount of the cathode waste gas returned by way of the cathode waste gas return pipe 6 can be fed to the burner device 16; or a portion of it can be returned to the burner device 16 and a portion fed directly to the cathode input KI via the control valve 7, bypassing the burner device 16. It can also be provided to feed the entire flow of the cathode waste gas returned by way of the cathode gas return pipe 6, while bypassing the burner device, directly to the cathode inlet pipe 15 or the cathode input KI.

The flows of the spent fuel gas returned from the anode output AO by way of the anode waste gas return pipe 17 and the spent cathode gas returned by way of the cathode waste gas return pipe 6 can be guided without any further addition of fresh air (that is, when the fresh-air control valve 10 is closed) through the burner device 16. As an alternative, a portion of the fresh air can be fed by way of the first fresh-air feed pipe 18, together with the returned anode waste gas and the returned cathode waste gas, to the burner device 16, and a portion of the fresh air can be fed by way of the second fresh-air feed pipe 19, while bypassing the burner device 16, directly to the cathode inlet pipe 15 or the cathode input KI. Finally, the entire flow of the cathode waste gas can be returned by way of the cathode gas return pipe 6, while bypassing the burner device 16 (specifically by way of the control valve 7 and the second fresh-air feed pipe 19), directly to the cathode inlet pipe 15 or to the cathode input KI, and that the fresh-air flow a) is fed exclusively by way of the first fresh-air feed pipe 18 and by way of the burner device 16, or b) partially by way of the first fresh-air feed pipe 18 and by way of the burner device 16 and partially by way of the second fresh-air feed pipe 19, while bypassing the burner device 16, is fed directly to the cathode inlet pipe 15 or to the cathode input KI.

This therefore makes it possible to freely vary over a very wide range the combustion conditions in the burner device 16 by means of the amount of the returned cathode waste gas flow as well as by means of the amount of the fresh-air flow fed to the burner device and to thus implement optimal combustion conditions in the burner device 16. For the burner 4 contained in the burner device 16, this means that fewer noble catalysts can be used or that a use of catalysts will not be necessary at all.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-19. (canceled)

20. A fuel cell assembly comprising:
at least one fuel cell, having an anode and a cathode;
an anode input for feeding fresh fuel gas to the anode and an anode output for removing spent fuel gas from the anode;
a cathode input for feeding fresh cathode gas to the cathode;
a cathode output for removing spent cathode gas from the cathode;
a fresh-air feed for feeding fresh air to the cathode input;
a burner device connected by way of an anode waste gas return pipe between the anode output and the cathode input, for afterburning of combustible residual constituents contained in the spent fuel gas leaving the anode output; and
a fresh-air feed for optionally adding fresh air to gases returned to the cathode input;
wherein the fresh-air feed contains a first fresh-air feed pipe connected to the burner device, for the optional feeding of fresh air together with the spent fuel gas to the burner device, and a second fresh-air feed pipe for feeding fresh air to the cathode input, while bypassing the burner device.

21. The fuel cell assembly according to claim 20, wherein control devices are provided for adjusting the fresh-air amounts fed by way of the first fresh-air feed pipe and by way of the second fresh-air feed pipe.

22. The fuel cell assembly according to claim 20, further comprising blowers for delivering adjustable amounts of fresh air in the first fresh-air feed pipe and in the second fresh-air feed pipe respectively.

23. The fuel cell assembly according to claim 20, further comprising a cathode waste gas return pipe coupled between the cathode output and at least one of the burner device and the cathode input, for returning at least a portion of the cathode waste gas.

24. The fuel cell assembly according to claim 23, wherein:
for returning a portion of the cathode waste gas to the cathode input, the cathode waste gs return pipe is coupled with the burner device, preferably by way of the second fresh-air return pipe, and is coupled directly with the cathode input; and
a control valve is provided for adjusting a ratio of cathode waste gas amounts returned to the burner device and to the cathode input respectively.

25. The fuel cell assembly according to claim 20, wherein the burner device contains a burner for burning combustible residual constituents contained in the anode waste gas and a heating device for heating fresh air fed by way of the first fresh-air feed pipe.

26. The fuel cell assembly according to claim 20, wherein the burner device contains a catalytic burner.

27. The fuel cell assembly according to claim 20, wherein the burner device contains a burner formed by a foam structure.

28. The fuel cell assembly according to claim 26, wherein:
the burner device contains a burner formed by a foam structure; and
the catalytic burner is formed by a catalytic coating constructed on the foam structure.

29. The fuel cell assembly according to claim 26, wherein
the burner device contains a burner formed by a foam structure; and
the heating device is an electric heating device which is formed by a structure of an electrically conductive foam material.

30. The fuel cell assembly according to claim 28, wherein:
the heating device is an electric heating device which is formed by a structure of an electrically conductive foam material; and
the catalytic coating is provided on the foam structure of the heating device.

31. The fuel cell assembly according to claim 29, wherein the foam structure comprises a constituent from the group consisting of special steel, FeCrAlY, steel and a conductive ceramic material.

32. The method of operating a fuel cell assembly having at least one fuel cell, having an anode and a cathode; an anode input for feeding fresh fuel gas to the anode and an anode output for removing spent fuel gas from the anode; a cathode input for feeding fresh cathode gas to the cathode; a cathode output for removing spent cathode gas from the cathode; a fresh-air feed for feeding fresh air to the cathode input; a burner device connected by way of an anode waste gas return pipe between the anode output and the cathode input, for afterburning of combustible residual constituents contained in the spent fuel gas leaving the anode output; and a fresh-air feed for optionally adding fresh air to gases returned to the cathode input; wherein the fresh-air feed contains a first fresh-air feed pipe connected to the burner device, for the optional feeding of fresh air together with the spent fuel gas to the burner device, and a second fresh-air feed pipe for feeding fresh air to the cathode input, while bypassing the burner device; said method comprising:
adjusting an amount of fresh air fed to the burner device by way of the first fresh-air feed pipe, such that a temperature of between 750° C. and 1,400° C., occurs during afterburning of combustible residual constituents contained in the spent fuel gas in the burner device.

33. The method according to claim 32, wherein said temperature is between 850° C. and 1250° C.

34. The method according to claim 32, wherein the flow of the spent fuel gas is returned in its entirety by way of the anode waste gas return pipe to the burner device.

35. The method according to claim 32, wherein flow of the cathode waste gas returned by way of the cathode waste gas return pipe returned in its entirety to the burner device.

36. The method according to claim 32, wherein part of the flow of the cathode waste gas returned by way of the cathode waste gas return pipe is returned to the burner device and part is returned to the cathode input.

37. The method according to claim 35, wherein the flows of the spent fuel gas and of the cathode waste gas are guided through the burner device without another addition of fresh air.

38. The method according to claim 32, wherein a portion of fed fresh air is fed to the burner device by way of the first fresh-air feed pipe.

39. The method according to claim 32, wherein:
the flow of the cathode waste gas, returned by way of the cathode waste gas return pipe, while bypassing the burner device, is returned entirely to the cathode input; and
fresh-air flow is fed by way of the first fresh-air feed pipe only to the burner device, or is partially fed by way of the first fresh-air feed pipe to the burner device and is partially fed by way of the second fresh-air feed pipe to the cathode input while bypassing the burner device.
